(19) United States
(12) Patent Application Publication
(10) Pub. No.: US 2025/0234122 A1
(43) Pub. Date: Jul. 17, 2025

(54) PROTECTED ACOUSTIC TRANSDUCER

(71) Applicants: W. L. Gore & Associates, Inc., Newark, DE (US); W. L. GORE & ASSOCIATES G.K., Tokyo (JP)

(72) Inventors: RAMAMOORTHY VENKATTARAMAN, Newark, DE (US); JONATHAN STASTKA, Newark, DE (US); CHAD BANTER, Newark, DE (US)

(21) Appl. No.: 18/854,179

(22) PCT Filed: Mar. 31, 2023
(86) PCT No.: PCT/US2023/065182

§ 371 Date: Oct. 4, 2024

Related U.S. Application Data
(60) Provisional application No. 63/326,928, filed on Apr. 4, 2022.

(30) Foreign Application Priority Data
Jun. 28, 2022 (EP) 22181676.2

(51) Int. Cl. H04R 1/08; H04R 1/02; H04R 1/44

(52) U.S. Cl. CPC H04R 1/086; H04R 1/023; H04R 1/44

(57) ABSTRACT

There is herein presented an acoustic device comprising an acoustic transducer, an acoustic channel proximate to the acoustic transducer and a membrane cover spanning the acoustic channel; wherein upon the installation of the membrane cover the signal to noise ratio (SNR) of the acoustic transducer is reduced by less than 1.5 dB as measured using the method described herein; and wherein the SNR of the acoustic device is reduced by less than 1.0 dB after contact of the membrane cover with water.

### FIELD

The present disclosure relates to acoustic devices that include a protected acoustic transducer covered with an acoustic vent.

### BACKGROUND

Acoustic devices including microphones and speakers typically include an acoustic transducer that receives or transmits sound respectively, typical in the range of around 16 Hz to 20 kHz, those frequencies that are audible to the human ear. In at least some applications it is necessary to cover the acoustic transducer of the acoustic device with a protective cover to protect the acoustic transducer from water and particulates.

Covering the acoustic transducer with a protective cover that is able to prevent ingress of particulates or liquid into the acoustic device often impairs the acoustic performance of the device due to the acoustic impedance of the protective cover reducing the effective signal to noise ratio of the acoustic transducer.

Protective covers used to protect acoustic transducers often sacrifice acoustic performance to ensure that the acoustic transducer is sufficiently protected from particulates and especially from water. Accordingly, there is a need for improved protective covers that provide sufficient protection from water and particulates but impair acoustic performance of the acoustic transducer as little as possible.

Alternatively, protective covers with improved acoustic performance have been provided that have much reduced ability to protect the acoustic transducer from particulates and especially water. This type of protective cover may be sufficient for those applications where water protection is of lesser importance.

Yet further, it is desired for protective covers to retain their acoustic performance after contact with any water, for example. Protective covers that retain their acoustic performance after contact with water, or even immersion in water, often have relatively poor initial acoustic performance, whereas protective covers that have good initial acoustic performance often have significantly reduced acoustic performance after contact with water or immersion in water.

Accordingly, there remains a need for improved acoustic devices comprising improved protective covers.

### SUMMARY

According to a first aspect, there is provided an acoustic device comprising an acoustic transducer, an acoustic channel proximate to the acoustic transducer and a membrane cover spanning the acoustic channel;
wherein upon the installation of the membrane cover the signal to noise ratio (SNR) of the acoustic transducer is reduced by less than 1.5 dB as measured using the method described herein; and
wherein the SNR of the acoustic device is reduced by less than 2.0 dB after immersion of the acoustic device in water at a depth of at least 0.5 m for at least 10 minutes.

Typically, the installation of a membrane cover over an acoustic transducer significantly impacts the performance of the acoustic transducer, typically by at least reducing the signal to noise ratio (SNR) for the acoustic transducer. In other words the SNR for the acoustic device before the membrane cover is installed is typically significantly better than after the membrane cover is installed.

The acoustic channel may be a passage that extends from the acoustic transducer to the exterior of the acoustic device. Accordingly, sound may pass from the exterior of the acoustic device to the acoustic transducer through the acoustic channel. In at least some embodiments the acoustic channel may be an acoustic cavity.

Membrane covers for acoustic applications typically are either resistive membrane covers or reactive membrane covers. Predominantly resistive membrane covers are typically sufficiently stiff and/or have sufficiently high airflow such that they do not bend, flex, or vibrate in response to acoustic energy passing through them. Predominantly reactive membrane covers are typically sufficiently flexible such that they bend, flex, or vibrate in response to acoustic energy passing through them.

Predominantly resistive membrane covers significantly reduce acoustic performance by reducing the SNR of the acoustic device due to an increase in the noise floor at higher frequencies.

Predominantly reactive membrane covers have minimum impact to the noise floor at the higher frequencies in comparison with predominantly resistive membrane covers but at lower frequencies have a higher loss in sensitivity and a higher noise floor to thereby reduce acoustic performance by reducing SNR.

Further, when an acoustic device comes into contact with water, the acoustic performance of the acoustic device may be further reduced. This reduction in SNR may be due to a physical change in the membrane cover induced by the contact with water. For example, after a significant water challenge, such as immersion of the acoustic device in water, the additional pressure of the water against the membrane cover may deform the membrane cover that is not recovered or is not recovered fully after the water challenge (i.e. the device is removed from the water and dried). Deformation of the membrane cover often degrades the acoustic performance of the membrane cover and therefore the acoustic performance of the acoustic device is often significantly degraded after a water challenge. This reduction in performance is typically more significant for predominantly reactive membrane covers than for predominantly resistive membrane covers.

A method of measuring the SNR and for measuring the change or reduction in SNR for an acoustic transducer or for an acoustic device are described in the detailed description below.

“Signal-to-noise ratio (SNR)” in dB as referred to herein is defined as 10 times the logarithm of the ratio of a standard signal's power to the noise power of the microphone created by its self-noise as defined by the following equation (Kinsler et al., 1999; International Organization for Standardization, 2019):

$$SNR = 10 \times Log ( Signal Power / Noise Power )$$

The standard signal is commonly generated by a sound calibrator or calibrated sound source with a 94 dB Sound Pressure Level (SPL) tone at a 1 kHz sound frequency. The Power Sum for both the Signal Power and Noise Power were calculated across the measured frequency range from 100 Hz to 10 kHz with an A-Weighting Filter applied to the spectrum. SNR is a relative measure, valid only for a given signal level, while self-noise is an absolute measure of the microphone quality. SNR at a calibrated SPL will however give a measure of self-noise, because it is obtained by subtracting the self-noise from the standard signal's level.

The acoustic transducer of the acoustic device may be considered to be a protected acoustic transducer when it is covered by the membrane cover.

In some embodiments the membrane cover may comprise a membrane. The membrane may consist of a polymer.

The polymer may be selected from the group consisting of polytetrafluoroethylene (PTFE), polyethylene (PE), poly(ethylene-co-tetrafluoroethylene) (ETFE), ultra-high molecular weight polyethylene (UHMWPE), polyparaxylylene (PPX), polylactic acid (PLLA) and any combination or blend thereof.

The polymer may be selected from the group consisting of polytetrafluoroethylene (PTFE), poly(ethylene-co-tetrafluoroethylene) (ETFE), or polyparaxylylene (PPX) and any combination or blend thereof.

In some embodiments the polymer may be PTFE. The polymer may be PE.

The polymer may be an expanded polymer. The polymer may be selected from expanded PTFE (ePTFE) and expanded polyethylene (ePE) and combinations and blends thereof. For example, the polymer may be ePTFE. The polymer may be ePE.

The membrane cover may comprise a coating. The coating may be provided on the membrane. The coating may provide the membrane cover with improved performance. For example, the coating may increase the water resistance of the membrane cover.

The membrane cover may have a water entry pressure (WEP) of at least 15 kPa. The membrane cover may have a WEP of at least 20 kPa. The membrane cover may have a WEP of at least 25 kPa. The membrane cover may have a WEP of at least 30 kPa. The membrane cover may have a WEP of at least 35 kPa. The membrane cover may have a WEP of at least 40 kPa. The membrane cover may have a WEP of at least 45 kPa. The membrane cover may have a WEP of at least 50 kPa.

The membrane cover may have a water entry pressure (WEP) of from about 15 kPa to about 200 kPa. The membrane cover may have a WEP of from about 20 kPa to about 200 kPa. The membrane cover may have a WEP of from about 25 kPa to about 200 kPa. The membrane cover may have a WEP of from about 30 kPa to about 200 kPa. The membrane cover may have a WEP of from about 35 kPa to about 200 kPa. The membrane cover may have a WEP of from about 40 kPa to about 200 kPa. The membrane cover may have a WEP of from about 45 kPa to about 200 kPa. The membrane cover may have a WEP of from about 50 kPa to about 200 kPa.

In some embodiments the acoustic device may comprise a housing. The housing may comprise the acoustic channel and the acoustic channel may extend from the acoustic transducer to the exterior of the acoustic device and the membrane cover may span and occlude the acoustic channel.

The membrane cover may be porous. The membrane cover may have a maximum pore size of from about 1 to about 20 μm. The membrane cover may have a maximum pore size of from about 1 to about 15 μm. The membrane cover may have a maximum pore size of from about 3 to about 10 μm. The membrane cover may have a maximum pore size of from about 4 to about 10 μm. The membrane cover may have a maximum pore size of from about 5 to about 10 μm.

The membrane may be porous. The membrane may have a maximum pore size of from about 1 to about 20 μm. The membrane may have a maximum pore size of from about 1 to about 15 μm. The membrane may have a maximum pore size of from about 3 to about 10 μm. The membrane cover may have a maximum pore size of from about 4 to about 10 μm. The membrane cover may have a maximum pore size of from about 5 to about 10 μm.

The membrane cover may have an airflow across the membrane cover of at least 3 cm³/cm² sec. The membrane cover may have an airflow across the membrane cover of at least 5 cm³/cm² sec. The membrane cover may have an airflow across the membrane cover of at least 7 cm³/cm² sec. The membrane cover may have an airflow across the membrane cover of at least 10 cm³/cm² sec. The membrane may have an airflow across the membrane of at least 3 cm³/cm² sec. The membrane may have an airflow across the membrane of at least 5 cm³/cm² sec. The membrane may have an airflow across the membrane of at least 7 cm³/cm² sec. The membrane may have an airflow across the membrane of at least 10 cm³/cm² sec.

The membrane cover may have an airflow across the membrane cover of from 3 cm³/cm² sec to 30 cm³/cm² sec. The membrane cover may have an airflow across the membrane cover of from 5 cm³/cm² sec to 30 cm³/cm² sec. The membrane cover may have an airflow across the membrane cover of from 7 cm³/cm² sec to 30 cm³/cm² sec. The membrane cover may have an airflow across the membrane cover of from 10 cm³/cm² sec to 30 cm³/cm² sec. The membrane may have an airflow across the membrane of from 3 cm³/cm² sec to 30 cm³/cm² sec. The membrane may have an airflow across the membrane of from 5 cm³/cm² sec to 30 cm³/cm² sec. The membrane may have an airflow across the membrane of from 7 cm³/cm² sec to 30 cm³/cm² sec. The membrane may have an airflow across the membrane of from 10 cm³/cm² sec to 30 cm³/cm² sec.

The membrane cover may have an airflow across the membrane cover of from 3 cm³/cm² sec to 20 cm³/cm² sec. The membrane cover may have an airflow across the membrane cover of from 5 cm³/cm² sec to 20 cm³/cm² sec. The membrane cover may have an airflow across the membrane cover of from 7 cm³/cm² sec to 20 cm³/cm² sec. The membrane cover may have an airflow across the membrane cover of from 10 cm³/cm² sec to 20 cm³/cm² sec. The membrane may have an airflow across the membrane of from 3 cm³/cm² sec to 20 cm³/cm² sec. The membrane may have an airflow across the membrane of from 5 cm³/cm² sec to 20 cm³/cm² sec. The membrane may have an airflow across the membrane of from 7 cm³/cm² sec to 20 cm³/cm² sec. The membrane may have an airflow across the membrane of from 10 cm³/cm² sec to 20 cm³/cm² sec.

The membrane may have a MPA less than about 3.0 g/m². The membrane may have a MPA less than about 2.5 g/m². The membrane may have a MPA less than about 2.0 g/m². The membrane may have a MPA less than about 1.7 g/m². The membrane may have a MPA less than about 1.5 g/m².

The membrane may have a MPA from about 1.1 g/m² to about 3.0 g/m². The membrane may have a MPA from about 1.1 g/m² to about 2.5 g/m². The membrane may have a MPA from about 1.1 g/m² to about 2.0 g/m². The membrane may have a MPA from about 1.1 g/m² to about 1.7 g/m². The membrane may have a MPA from about 1.1 g/m² to about 1.5 g/m².

The membrane may have a MPA from about 1.3 g/m² to about 3.0 g/m². The membrane may have a MPA from about 1.3 g/m² to 2.5 g/m². The membrane may have a MPA from about 1.3 g/m² to about 2.0 g/m². The membrane may have a MPA from about 1.3 g/m² to about 1.7 g/m². The membrane may have a MPA from about 1.3 g/m² to about 1.5 g/m².

The membrane may have a MPA from about 1.3 g/m² to about 3.0 g/m². The membrane may have a MPA from about 1.5 g/m² to about 3.0 g/m². The membrane may have a MPA from about 1.7 g/m² to about 3.0 g/m². The membrane may have a MPA from about 2.0 g/m² to about 3.0 g/m².

The membrane may comprise an open or substantially open micro-structure. The micro-structure may comprise voids such that at least 30% of the microstructure of the membrane is void. The micro-structure may comprise voids such that at least 50% of the microstructure of the membrane is void. The micro-structure may comprise voids such that at least 70% of the microstructure of the membrane is void. Typically, the voids of the micro-structure allow the passage of air through the membrane. Accordingly, at least the majority of the voids of the micro-structure are free from obstructions or other materials that would impede the passage or flow of air through the membrane. The membrane cover may not comprise an elastomer. The membrane may not comprise an elastomer.

The SNR of the acoustic transducer may be reduced by less than about 1.5 dB compared to the SNR of the acoustic transducer without the membrane cover. The SNR of the acoustic transducer may be reduced by less than about 1.3 dB compared to the SNR of the acoustic transducer without the membrane cover. The SNR of the acoustic transducer may be reduced by less than about 1.0 dB compared to the SNR of the acoustic transducer without the membrane cover. The SNR of the acoustic transducer may be reduced by less than about 0.7 dB compared to the SNR of the acoustic transducer without the membrane cover. The SNR of the acoustic transducer may be reduced by less than about 0.5 dB compared to the SNR of the acoustic transducer without the membrane cover.

The SNR of the acoustic transducer may be reduced by from about 0.1 dB to about 1.5 dB compared to the SNR of the acoustic transducer without the membrane cover. The SNR of the acoustic transducer may be reduced by from about 0.1 dB to about 1.3 dB compared to the SNR of the acoustic transducer without the membrane cover. The SNR of the acoustic transducer may be reduced by from about 0.1 dB to about 1.0 dB compared to the SNR of the acoustic transducer without the membrane cover. The SNR of the acoustic transducer may be reduced by from about 0.1 dB to about 0.7 dB compared to the SNR of the acoustic transducer without the membrane cover. The SNR of the acoustic transducer may be reduced by from about 0.1 dB to about 0.5 dB compared to the SNR of the acoustic transducer without the membrane cover.

The SNR of the acoustic device may be reduced by less than about 1 dB after immersion of the acoustic device in water as measured using the method described herein. The SNR of the acoustic device may be reduced by less than about 0.75 dB after immersion of the acoustic device in water as measured using the method described herein. The SNR of the acoustic device may be reduced by less than about 0.5 dB after immersion of the acoustic device in water as measured using the method described herein. The SNR of the acoustic device may be reduced by less than about 0.25 dB after immersion of the acoustic device in water as measured using the method described herein. The SNR of the acoustic device may be reduced by less than about 0.1 dB after immersion of the acoustic device in water as measured using the method described herein.

The SNR of the acoustic device may be reduced by from about 0.0 to about 1.0 dB after immersion of the acoustic device in water as measured using the method described herein. The SNR of the acoustic device may be reduced by from about 0.0 to about 0.75 dB after immersion of the acoustic device in water as measured using the method described herein. The SNR of the acoustic device may be reduced by from about 0.0 to about 0.5 dB after immersion of the acoustic device in water as measured using the method described herein. The SNR of the acoustic device may be reduced by from about 0.0 to about 0.25 dB after immersion of the acoustic device in water as measured using the method described herein. The SNR of the acoustic device may be reduced by from about 0.0 to about 0.1 dB after immersion of the acoustic device in water as measured using the method described herein.

The SNR of the acoustic device may be reduced by from about 0.1 to about 1.0 dB after immersion of the acoustic device in water as measured using the method described herein. The SNR of the acoustic device may be reduced by from about 0.1 to about 0.75 dB after immersion of the acoustic device in water as measured using the method described herein. The SNR of the acoustic device may be reduced by from about 0.1 to about 0.5 dB after immersion of the acoustic device in water as measured using the method described herein. The SNR of the acoustic device may be reduced by from about 0.1 to about 0.25 dB after immersion of the acoustic device in water as measured using the method described herein. The SNR of the acoustic device may be reduced by from about 0.1 to about 0.1 dB after immersion of the acoustic device in water as measured using the method described herein.

When determining the reduction in SNR of the acoustic device after immersion in water, the acoustic device may be immersed in water to a specific depth. The acoustic device may be immersed in water to a depth of at least 0.1 m. The acoustic device may be immersed in water to a depth of at least 0.5 m. The acoustic device may be immersed in water to a depth of at least 1 m. The acoustic device may be immersed in water to a depth of at least 1.5 m. The acoustic device may be immersed in water to a depth of at least 2 m. The acoustic device may be immersed in water to a depth of at least 2.5 m. For example, the acoustic device may be immersed in water to a depth of 0.5 m. The acoustic device may be immersed in water to a depth of 1 m. The acoustic device may be immersed in water to a depth of 1.5 m. The acoustic device may be immersed in water to a depth of 2 m. The acoustic device may be immersed in water to a depth of 2.5 m.

When determining the reduction in SNR of the acoustic device after immersion in water, the acoustic device may be immersed in water for a specific period of time. The acoustic device may be immersed in water for a period of 10 minutes. The acoustic device may be immersed in water for a period of 20 minutes. The acoustic device may be immersed in water for a period of 30 minutes. The acoustic device may be immersed in water for a period of at least 10 minutes. The acoustic device may be immersed in water for a period of 20 minutes. The acoustic device may be immersed in water for a period of at least 30 minutes.

For example, in some embodiments the SNR of the acoustic device may be reduced by less than 1.0 dB after immersion of the acoustic device in water at a depth of 2 m for a period of 30 minutes. In some embodiments, the SNR of the acoustic device may be reduced by less than 1.0 dB after immersion of the acoustic device in water at a depth of 1.5 m for a period of 30 minutes. In some embodiments, the SNR of the acoustic device may be reduced by less than 1.0 dB after immersion of the acoustic device in water at a depth of 1 m for a period of 30 minutes. In some embodiments, the SNR of the acoustic device may be reduced by less than 1.0 dB after immersion of the acoustic device in water at a depth of 0.5 m for a period of 30 minutes.

It will be readily understood by those skilled in the art that the methods described above for water immersion of the acoustic device (“water challenge”) are applicable to any of the SNR requirements described herein and do not only apply to the example reductions in SNR provided in the paragraph above.

In some embodiments the acoustic device comprises an acoustic transducer, an acoustic channel proximate to the acoustic transducer and a membrane cover spanning the acoustic channel;
the membrane cover comprises a membrane consisting of polytetrafluoroethylene (PTFE) having a mass per area (MPA) of less than 3.0 g/m²;
wherein the signal to noise ratio (SNR) of the acoustic transducer is reduced by less than 1.5 dB when compared to the SNR of the acoustic transducer without the membrane cover as measured using the method described herein; and
wherein the SNR of the acoustic device is reduced by less than 1.0 dB after immersion of the acoustic device in water as measured using the method described herein.

In a second aspect, an acoustic cover is presented, the acoustic cover comprising a membrane, the acoustic cover being configured to cover an acoustic transducer to thereby protect the acoustic transducer and to reduce the signal to noise ratio (SNR) of the acoustic transducer by less than 1.5 dB compared to the SNR of the acoustic transducer without the acoustic cover as measured using the method as described herein.

The membrane may comprise a polymer. The polymer may be selected from the group consisting of polytetrafluoroethylene (PTFE), polyethylene (PE), poly(ethylene-co-tetrafluoroethylene) (ETFE), ultra-high molecular weight polyethylene (UHMWPE), polyparaxylylene (PPX), polylactic acid (PLLA) and any combination or blend thereof. For example, the polymer may be PTFE.

The polymer may be selected from the group consisting of polytetrafluoroethylene (PTFE), poly(ethylene-co-tetrafluoroethylene) (ETFE), or polyparaxylylene (PPX) and any combination or blend thereof. For example, the polymer may be PTFE.

The polymer may be PTFE or PE.

The polymer may be an expanded polymer. The polymer may be selected from expanded PTFE (ePTFE) and expanded polyethylene (ePE) and combinations and blends thereof. For example, the polymer may be ePTFE. The polymer may be ePE.

In some embodiments where the membrane is a PTFE membrane, the PTFE membrane may have a mass per area (MPA) of less than 3.5 g/m². The PTFE membrane may have a MPA of less than 3.0 g/m². The PTFE membrane may have a MPA of less than 2.5 g/m². The PTFE membrane may have a MPA less than 2.0 g/m². The PTFE membrane may have a MPA less than 1.7 g/m². The PTFE membrane may have a MPA less than 1.5 g/m².

The PTFE membrane may have a MPA from 1.1 g/m² to 3.0 g/m². The PTFE membrane may have a MPA from 1.1 g/m² to 2.5 g/m². The PTFE membrane may have a MPA from 1.1 g/m² to 2.0 g/m². The PTFE membrane may have a MPA from 1.1 g/m² to 1.7 g/m². The PTFE membrane may have a MPA from 1.1 g/m² to 1.5 g/m².

The PTFE membrane may have a MPA from 1.3 g/m² to 3.0 g/m². The PTFE membrane may have a MPA from 1.3 g/m² to 2.5 g/m². The PTFE membrane may have a MPA from 1.3 g/m² to 2.0 g/m². The PTFE membrane may have a MPA from 1.3 g/m² to 1.7 g/m². The PTFE membrane may have a MPA from 1.3 g/m² to 1.5 g/m².

The PTFE membrane may have a MPA from 1.3 g/m² to 3.0 g/m². The PTFE membrane may have a MPA from 1.5 g/m² to 3.0 g/m². The PTFE membrane may have a MPA from 1.7 g/m² to 3.0 g/m². The PTFE membrane may have a MPA from 2.0 g/m² to 3.0 g/m².

In some embodiments where the membrane is a PE membrane, the PE membrane may have a mass per area (MPA) of less than 3.5 g/m². The PE membrane may have a MPA of less than 3.0 g/m². The PE membrane may have a MPA of less than 2.5 g/m². The PE membrane may have a MPA less than 2.0 g/m². The PE membrane may have a MPA less than 1.7 g/m². The PE membrane may have a MPA less than 1.5 g/m².

The PE membrane may have a MPA from 1.1 g/m² to 3.0 g/m². The PE membrane may have a MPA from 1.1 g/m² to 2.5 g/m². The PE membrane may have a MPA from 1.1 g/m² to 2.0 g/m². The PE membrane may have a MPA from 1.1 g/m² to 1.7 g/m². The PE membrane may have a MPA from 1.1 g/m² to 1.5 g/m².

The PE membrane may have a MPA from 1.3 g/m² to 3.0 g/m². The PE membrane may have a MPA from 1.3 g/m² to 2.5 g/m². The PE membrane may have a MPA from 1.3 g/m² to 2.0 g/m². The PE membrane may have a MPA from 1.3 g/m² to 1.7 g/m². The PE membrane may have a MPA from 1.3 g/m² to 1.5 g/m².

The PE membrane may have a MPA from 1.3 g/m² to 3.0 g/m². The PE membrane may have a MPA from 1.5 g/m² to 3.0 g/m². The PE membrane may have a MPA from 1.7 g/m² to 3.0 g/m². The PE membrane may have a MPA from 2.0 g/m² to 3.0 g/m².

The acoustic cover may have a water entry pressure (WEP) of at least 15 kPa. The acoustic cover may have a WEP of at least 20 kPa. The acoustic cover may have a WEP of at least 25 kPa. The acoustic cover may have a WEP of at least 30 kPa. The acoustic cover may have a WEP of at least 35 kPa. The acoustic cover may have a WEP of at least 40 kPa. The acoustic cover may have a WEP of at least 45 kPa. The acoustic cover may have a WEP of at least 50 kPa.

In some embodiments, the acoustic cover may be configured when installed in an acoustic device to reduce the SNR of the acoustic transducer of the acoustic device by less than 1.0 dB compared to the SNR of the acoustic transducer without the acoustic cover after the acoustic cover has been contacted with water.

Accordingly, the acoustic cover may be the membrane cover in the acoustic device of the first aspect.

In some embodiments, the acoustic cover may have an airflow across the membrane cover of at least 5 cm³/cm² sec (F). The membrane cover may have an airflow across the membrane cover of at least 7 cm³/cm² sec (F). The membrane cover may have an airflow across the membrane cover of at least 10 cm³/cm² sec (F).

Preferred and optional features of the membrane cover of the first aspect are preferred and optional features of the acoustic cover of the second aspect.

### BRIEF DESCRIPTION OF THE FIGURES

Embodiments of the present invention will now be described, by way of non-limiting example, with reference to the accompanying drawings.

FIG. 1: A schematic side view of an embodiment of an acoustic device;

FIG. 2: A plot of change in SNR (delta (A) SNR) and the change in SNR after water challenge (SNR_{wc}) vs MPA for embodiments mounted over an aperture with an internal diameter (ID) of A) 1.2 mm, and B) 1.0 mm and 1.6 mm;

FIG. 3: Comparison of acoustic impedance (Rayls) as a function of frequency for membranes of 1.47 gsm or g/m² and of 4.26 gsm or g/m²;

FIG. 4: Typical performance of a predominantly reactive ePTFE membrane before and after a water challenge (eWEP);

FIG. 5: A chart of change in SNR after water challenge for predominantly reactive membranes and predominantly resistive membranes;

FIG. 6: A plot of ΔSNR for ePE (open diamond) and ePTFE (open circle) membranes mounted over an aperture with an internal diameter (ID) of 1 mm;

FIG. 7: A plot of ΔSNR (closed diamonds) and SNR after water challenge (SNR (Wc), open diamonds)) for an ePE membrane over an aperture having an internal diameter of 1 mm;

FIG. 8: A plot of ΔSNR and SNR after water challenge (SNR (Wc)) for an ePE membrane over an aperture having an internal diameter of 1.5 mm; and

FIG. 9: A schematic side view of an embodiment of an acoustic device.

### DETAILED DESCRIPTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

### Test Methods

### Measurement of SNR

The following method was used to measure the SNR of the acoustic device, including the microphone (corresponding to an acoustic transducer), before installation of a membrane cover, after installation of the membrane cover, and after the acoustic transducer was put through a water challenge as described below.

A MEMS Microphone system (acoustic device) was placed in an Anechoic Box and separated from the Acoustic Source by a distance of 10 cm. The Source was first driven with a Single Frequency excitation of 1 Pa at 1 kHz to acquire the Signal Level Power of the MEMS Microphone. The Microphone Noise Power was acquired without any signal excitation to capture the noise floor of the MEMS Microphone. The SNR of the MEMS Microphone could then be estimated using the following formula:

$$SNR = 10 \times log ( Signal Level Power / Microphone Noise Power )$$

A-Weighting Filter was applied for both the Signal Level Power and the Microphone Noise Power measurements.

The MEMS microphone used in the following examples was a commercial top port microphone from Knowles—SPH1642HT5H-1 and the membrane cover was attached onto the device to cover the microphone. The SNR of the microphone without the membrane cover was 65 dB.

The SNR of the microphone in the acoustic device was measured before the membrane cover of each example was installed (SNRᵢ). The membrane cover was installed over the microphone and the SNR of the acoustic device was measured again (SNR_{f}). The change in SNR (ΔSNR) was determined as the SNR of the acoustic device after installation of the membrane cover minus the SNR of the acoustic device before installation of the membrane cover.

Measurement of SNR after Water Challenge

The acoustic device to which the membranes in the examples 1, 2 and comparative example 1 were mounted and were immersed in water to a depth of 2 m for a period of 30 minutes. The acoustic device was then retrieved and dried and the SNR of the acoustic device was measured again. The difference between the SNR of the device before it was immersed in water and the SNR of the device after it was immersed was determined (SNR_{wc}).

The acoustic device to which the membranes in example 3 were mounted and were immersed in water to a depth of 0.5 m for a period of 30 minutes. The acoustic device was then retrieved and dried and the SNR of the acoustic device was measured again. The difference between the SNR of the device before it was immersed in water and the SNR of the device after it was immersed was determined (SNR_{wc}).

### Measurement of Thickness

The thickness of the membranes was measured using a non-contact method using an optical digital micrometer (controller LS-7600, laser LS-7010MR, target LS-7010MT as provided by Keyence (UK) Ltd, UK). A sample of the membranes was arranged over a cylindrical stem with a hemispherical head. Minimal tension was applied to the membrane to ensure that the membrane was not stretched. The cylindrical stem was positioned between the laser and target/sensor. The tangential point of the laser beam height is recorded and this delta gives the thickness of the membrane.

### Measurement of Acoustic Impedance

Acoustic impedance was measured using the standard test method as defined in ASTM Standard ASTM 2611-17.

### Water Entry Pressure (WEP)

WEP relates to water intrusion through a material. WEP values were determined according to the following procedure. The test sample (1.5 mm diameter circular membrane sample) was held on a sample holder by means of a clamp. The sample was then pressurized with water. The pressure at which water breaks through via the membrane occurs was recorded as the Water Entry Pressure (WEP).

### Air Permeability

Air permeability was measured by clamping a test sample in a circular gasketed flanged fixture 14 cm in diameter. The upstream side of the sample fixture was connected to a flow meter in line with a source of dry compressed air. The downstream side of the sample fixture was open to the atmosphere.

Testing was accomplished by applying an air pressure of 1.3 cm of water to the upstream side of the sample and recording the flow rate of air passing through the in-line flow meter (a ball-float rotameter).

Results are reported in terms of Frazier Number which has units of cubic cm per square cm per s.

### Air Flow Resistance

Rayl is a measure of the resistance of the sample to air flow. The pressure drop (ΔP) through the sample (diameter of 4 cm) was measured at a fixed air flow rate of 10 standard cubic feet per minute (scfh). The pressure drop was converted to Rayl units using the equation below:

$$Resistance ( in Rayls ) = \frac{Δ P \cdot Area of sample}{Flowrate}$$

For acoustically resistive materials, air flow resistance correlates directly to acoustic resistivity.

### Mass Per Area

Five circles of 100 cm² area are cut from a representative sample of membrane. The mass for each circle is measured on an analytical balance accurate in grams to three decimal places. Values in grams per 100 square centimeters are converted to grams per square meter by multiplying by 100. Mass per area values were averaged and reported in units of grams per square meter (g/m²).

### Membranes Used in the Examples

Expanded polytetrafluoroethylene (ePTFE) membranes were produced according to the teaching of U.S. Pat. No. 5,814,405 to Branca et al. and of U.S. Pat. No. 7,306,729 to Bacino et al. which are incorporated herein by reference in their entirety. The prepared dried precursor tape was expanded at modified expansion ratios to produce the ePTFE membranes according the examples provided below.

Expanded polyethylene (ePE) membranes were produced by the following method. A ultra-high molecular weight polyethylene (UHMWPE) resin having a molecular weight of approximately 7.6 million g/mol was obtained. A tape was prepared by the methods according to U.S. Pat. No. 9,926,416 to Sbriglia et al. which is incorporated herein by reference in its entirety to produce a tape having a thickness of 0.14 mm. The tape was preheated at 135° C. for 30 seconds and then expanded in the machine direction at an expansion ratio of 1.5:1 at 150% per second and in the transverse direction at an expansion ratio of 2:1 at 300% per second to produce a membrane. The membrane was preheated at 160° C. for 15 seconds and then expanded in the machine direction at a ratio of 4.5:1 at 0.7% per second and in the transverse direction at an expansion ratio of 8:1 at 1.4% per second.

### Example 1

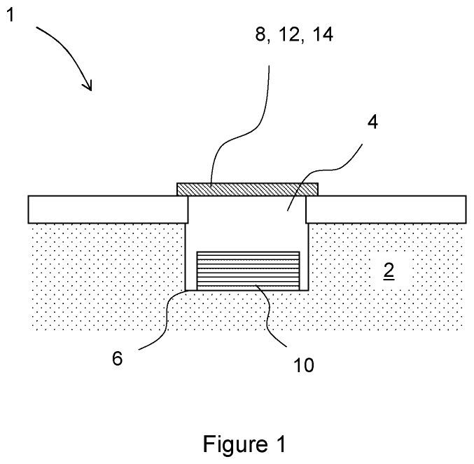

With reference to FIG. 1, an acoustic device 1 comprises a device body 2, a channel 4, an acoustic cavity 6, and a membrane cover 8. The acoustic cavity 6 extends into the device body 2 to the channel 4. A microphone 10 is provided in the channel 4 and the membrane cover 8 spans the channel 4. The channel had an inner diameter (ID) of 1.2 mm. Accordingly, the membrane cover 8 occludes the channel 4 to ensure that the microphone 10 is protected from foreign material.

The membrane cover 8 comprises an ePTFE membrane made according to the method described above expanded at a modified expansion ratio to produce a membrane having a thickness of 50.6 μm and is adhered to the device body 2. The ePTFE membrane had a mass per area of 1.5 g/m².

The signal to noise ratio (SNR) of the acoustic device 1 was measured before the membrane cover 8 was installed to provide the initial SNR, SNRᵢ. Once the membrane cover 8 was installed, the SNR was again measured of the acoustic device to provide the final SNR, SNR_{f}. The change in the SNR of the acoustic device was taken to be ΔSNR=SNR_{f}−SNRᵢ.

The acoustic device 1 was then subject to a water challenge by submersion of the acoustic device in water to a depth of 2 meters for 30 minutes. The SNR of the acoustic device 1 after the water challenge, SNR_{wc}, was measured and compared to the ΔSNR.

### Example 2

An acoustic device as described above for example 1 was prepared and provided with a membrane cover 12.

The membrane cover 12 comprises an ePTFE membrane made according the method described above expanded at a modified expansion ratio to produce a membrane having a thickness of 96.3 μm and is adhered to the device body 2. The ePTFE membrane had a mass per area of 2.9 g/m².

ΔSNR was calculated as described above and SNR_{wc} was measured as described above for Example 1.

### Example 3

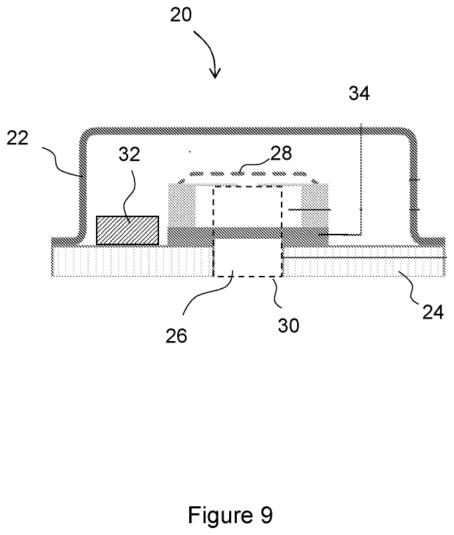

Referring to FIG. 9, an acoustic device 20 comprises a housing 22 positioned on a substrate 24, and an aperture 26 in the substrate 24. An acoustic transducer 28 and an acoustic channel 30 extending from the acoustic transducer, through the aperture 26 to the exterior of the acoustic device 20 is provided within the housing 22. In addition, an application-specific integrated circuit (ASIC) 32 was provided within the housing 22 to receive data from the acoustic transducer 28. An ePE membrane 34 made according to the method above spans and occludes the aperture 26, thereby spanning and occluding the acoustic channel 30. The ePE membrane 34 had a thickness of 12.9 μm. The ePE membrane 34 had a mass per area of 0.9 g/m².

ΔSNR was calculated as described above and SNR_{wc} was measured as described above for Example 1.

### Comparative Example 1

A comparative example acoustic device comprises the device as described above with a membrane cover 14.

The membrane cover 14 comprises an ePTFE membrane made according the method described above expanded at a modified expansion ratio to produce a membrane having a thickness of 125.8 μm and is adhered to the device body 2. The membrane cover 14 comprised an ePTFE membrane that had a mass per area of 4.3 g/m².

SNRᵢ, SNR_{f} were measured and ΔSNR was calculated and SNR_{wc} was measured as described above for Example 1.

### Comparative Example 2

A comparative example acoustic device comprises the device as described above with a membrane cover 16.

The membrane cover 16 comprises an ePTFE membrane commercially available from W. L. Gore & Associates, Inc. under part number PE13. The commercial example had a MPA of 5.3 g/m² with an air permeability of 7.4 cm³/cm² sec and was found to have a ΔSNR of −4.0 dB.

SNRᵢ, SNR_{f} were measured and ΔSNR was calculated and SNR_{wc} was measured as described above for Example 1.

ΔSNR and SNR_{wc} for the examples and comparative example are provided in Table 1 below:

TABLE 1
Parameters for acoustic devices comprising membrane covers
according to examples 1 to 3 and comparative example 1.

| | | | | Comparative |
|---|---|---|---|---|
| | Example 1 | Example 2 | Example 3 | Example 1 |
| ΔSNR (dB) | −0.8 | −1.39 | −1.24 | −1.54 |
| SNR_{wc} (dB) | 0.3 | 0.1 | −0.18 | −0.1 |
| Air permeability (F) | 13.25 | 10.9 | 21.6 | 9.97 |
| MPA (g/m²) | 1.5 | 2.9 | 0.9 | 4.3 |
| Thickness (μm) | 50.6 | 96.3 | 12.9 | 125.8 |

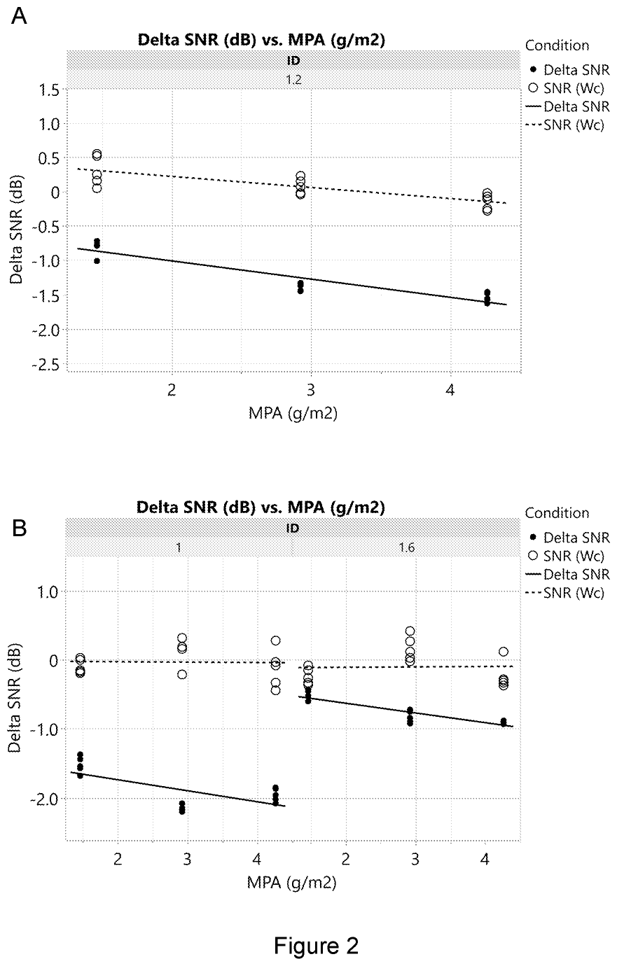

FIG. 2A shows data for ΔSNR and SNR_{wc} for the examples 1 and 2 and comparative example 1, and FIG. 2B shows similar data for corresponding examples where the internal diameter of the aperture across which the membrane cover spans were 1.0 mm and 1.6 mm.

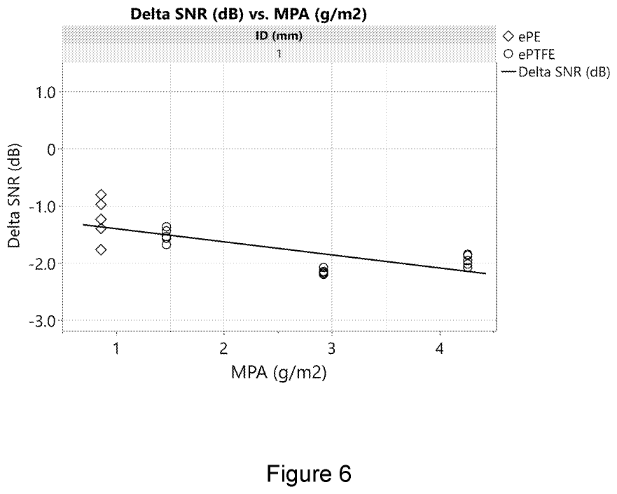

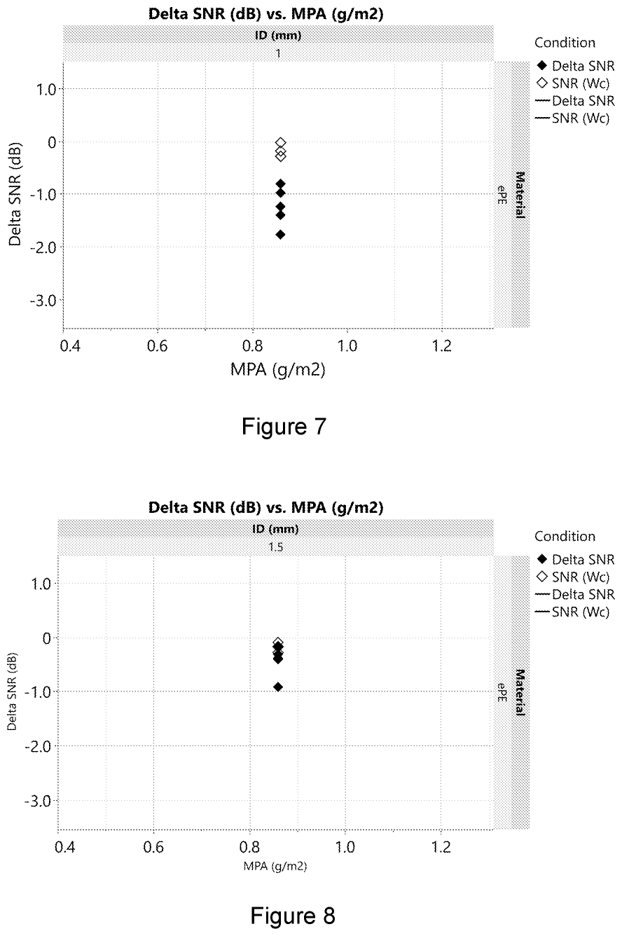

FIG. 6 shows data for ΔSNR for examples 1-3 and comparative example 1. FIGS. 7 and 8 show data for ΔSNR and SNR_{W}c for example 3 mounted over an aperture having an internal diameter of 1 mm (FIG. 7) and 1.5 mm (FIG. 8).

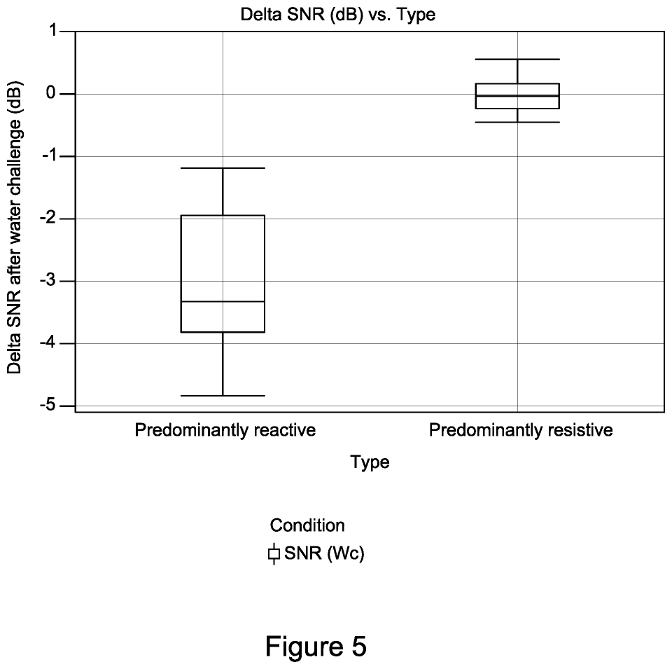

As shown with Comparative Example 2, predominantly resistive membranes have lesser acoustic performance (ΔSNR of −4.0) but are typically largely unaffected by significant water challenges (see FIG. 5).

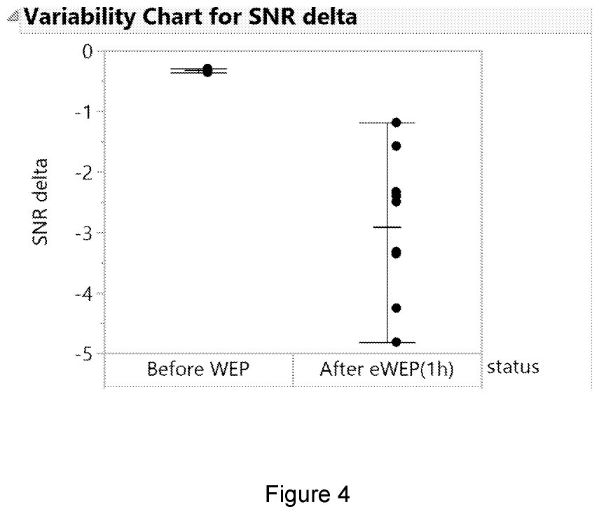

Predominantly reactive membranes typically have very good SNR (see FIG. 4 “Before WEP”). However, the acoustic performance of typical “reactive membranes” are significantly impaired by water challenges, whereas predominantly resistive membranes are not. This is shown in FIG. 5 and FIG. 4 (After eWEP(1h)).

For example, FIG. 4 shows the change in SNR for a typical reactive membrane compared to the SNR of the microphone before installation of the membrane cover or vent (ΔSNR, “Before WEP”), and the change in SNR of the acoustic device including the membrane cover or vent after water challenge (SNR_{wc} “after eWEP (1 h)”). As can be seen, the ΔSNR is very low for reactive membranes but the SNR_{wc} is very poor.

In contrast, the acoustic devices of examples 1-3 provide good acoustic performance (ΔSNR) whilst also maintaining good acoustic performance after water challenge (SNR_{wc}).

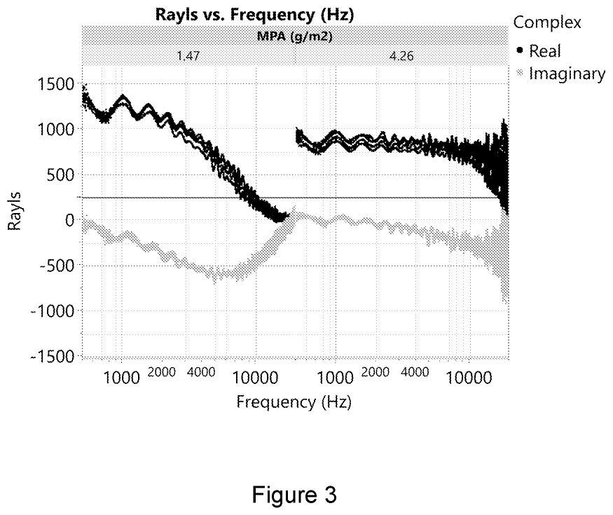

FIG. 3 shows the acoustic impedance as a function of frequency for the membranes of example 1 and comparative example 1. As can be seen, the comparative example displays predominantly resistive characteristics, whilst the membrane for example 1 shows reactive and resistive characteristics.

While there has been hereinbefore described approved embodiments of the present invention, it will be readily apparent that many and various changes and modifications in form, design, structure and arrangement of parts may be made for other embodiments without departing from the invention and it will be understood that all such changes and modifications are contemplated as embodiments as a part of the present invention as defined in the appended claims.

1. An acoustic device comprising an acoustic transducer, an acoustic channel proximate to the acoustic transducer and a membrane cover spanning the acoustic channel;
wherein upon the installation of the membrane cover the measured signal to noise ratio (SNR) of the acoustic transducer is reduced by less than 1.5 dB as measured using the method described herein; and
wherein the SNR of the acoustic device is reduced by less than 2.0 dB after immersion of the acoustic device in water at a depth of at least 0.5 m for at least 10 minutes.

2. The acoustic device of claim 1, wherein the membrane cover comprises a membrane and the membrane consists of a polymer.

3. The acoustic device of claim 2, wherein the polymer is selected from the group consisting of polytetrafluoroethylene (PTFE), polyethylene (PE), poly(ethylene-co-tetrafluoroethylene) (ETFE), ultra-high molecular weight polyethylene (UHMWPE), polyparaxylylene (PPX), polylactic acid (PLLA) and any combination or blend thereof.

4. The acoustic device of claim 2, wherein the polymer is an expanded polymer and the polymer is selected from the expanded PTFE (ePTFE) and expanded polyethylene (ePE) and combinations and blends thereof.

5. The acoustic device of claim 1, wherein the membrane cover has a water entry pressure (WEP) of at least 15 kPa.

6. The acoustic device of claim 1, wherein the SNR of the acoustic device is reduced by less than 2 dB after immersion of the acoustic device in water at a depth of 2 m for a period of 30 minutes.

7. The acoustic device of claim 1, wherein the acoustic device comprises a housing, the housing comprising the acoustic channel extending from the acoustic transducer to the exterior of the acoustic device and the membrane cover spans the acoustic channel.

8. The acoustic device of claim 1, wherein the membrane cover has an airflow across the membrane cover of at least 5 cm³/cm² sec.

9. The acoustic device of claim 1, wherein the membrane has a mass per area (MPA) less than 3 g/m² and the SNR of the acoustic transducer is reduced by less than 1.5 dB compared to the SNR of the acoustic transducer without the membrane cover as measured using the method described herein.

10. An acoustic cover comprising a PTFE or a PE membrane, the acoustic cover being configured to cover an acoustic transducer to thereby protect the acoustic transducer and to reduce the signal to noise ratio (SNR) of the acoustic transducer by less than 1.5 dB compared to the SNR of the acoustic transducer without the acoustic cover as measured using the method as described herein.

11. The acoustic cover of claim 10, wherein the PTFE membrane or PE membrane has a mass per area (MPA) of less than 3.0 g/m².

12. The acoustic cover of claim 10, wherein the acoustic cover has a water entry pressure of at least 15 kPa.

13. The acoustic cover of claim 10, wherein the acoustic cover is configured when installed in an acoustic device to reduce the SNR of the acoustic transducer of the acoustic device by less than 2.0 dB compared to the SNR of the acoustic transducer without the acoustic cover after the acoustic cover has been contacted with water.

14. The acoustic cover of claim 10, wherein the acoustic cover has an airflow across the membrane cover of at least 5 cm³/cm² sec.
